(19) United States
(12) Patent Application Publication
(10) Pub. No.: US 2011/0047026 A1
(43) Pub. Date: Feb. 24, 2011

(54) USING AUCTION TO VARY ADVERTISEMENT LAYOUT

(75) Inventors: Jody D. Biggs, Redmond, WA (US); Kamal Jain, Bellevue, WA (US); Deepak Pawar, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/545,666

(22) Filed: Aug. 21, 2009

(51) Int. Cl. G06Q 30/00

(52) U.S. Cl. 705/14.46

(57) ABSTRACT

A layout in which advertisements are displayed may be determined by auction. Several layouts may be defined, each having one or more slots of different relative values. Bids are received from advertisers, and an auction may be held to determine in which slots the different advertisers are placed, and which layout is to be used. The expected revenue from each layout may be calculated, and the layout may be chosen that maximizes the revenue that is expected to result from showing a particular layout to a user. In one example, there are layouts that offer exclusive and non-exclusive mainlines. Mainline exclusivity may be offered to an advertiser that has bid a sufficiently high amount per click that awarding the mainline exclusively to the advertiser can offset the loss of revenue expected from moving other advertisers off the mainline.

### BACKGROUND

Web advertising is normally sold in an auction. Potential advertisers typically bid on keywords. Each advertiser's bid represents the amount of money that the advertiser is willing to pay to receive a click from a user who has searched on a given keyword. Each time a search on that keyword occurs, a virtual auction is held, which decides which ads will be shown in the search results, and where on the page those ads will be placed. A results page typically contains a number of advertising slots, and the different slots have different relative values based on how likely a given slot is to generate a click. E.g., a slot at the top of the page may be more likely to generate a click (and, thus, may have a higher relative value) than a slot near the bottom of the page or off to the side. Slots on the page are awarded based on the bids, and possibly on other factors. One example version of an auction awards slots in order of the amount per bid. Another version of the auction determines the various ads' expected revenue per impression (by multiplying an advertiser's bid by its “click through rate”—i.e., the percentage of normalized impressions of that ad that are expected to result in a click), and awards slots in order of expected revenue.

One issue that arises in awarding advertising slots is that the arrangement of slots on a page is normally inflexible. For example, a search results page might have three “mainline” slots (slots above the algorithmic search results), and five “sidebar” slots (slots that are located off to the side of the page). In such an arrangement, the first-, second-, and third-ranked bidders for a given keyword will all receive mainline placement, as long as any applicable reserve price for mainline placement has been met. However, there are situations where placing all three of the top-ranked bidders on the mainline is economically inefficient. For example, the bids may reflect that mainline placement is worth much more to one of the top three bidders than it is to the other two. This allows the second- and third-ranked bidders to distract attention from the first-ranked bidder, even though if bid prices indicate that the attention is worth far more to the first-ranked bidder. In such a case, the top three bidders may pay far less per click than the top-ranked bidder was willing to pay. Moreover, the possibility that a bidder can obtain mainline placement even without being the first-ranked bidder tends to encourage underbidding.

### SUMMARY

An auction for advertising space may be held in which the layout of advertisements is one of the assets that is being auctioned. In one example, there are two layouts: one with a plural-slot mainline, and another with a single-slot (exclusive) mainline. In the plural-slot mainline, the first slot may be considered to have the highest value. The single slot in the exclusive mainline, however, may be considered to have a higher value than the first slot in the plural-slot mainline. For example, the single slot in the exclusive mainline might be considered twenty percent more effective at generating clicks than the first slot in the plural slot mainline. Since the auctioneer of the slots is paid for generating click-throughs (i.e., clicks by users on advertising links), an auction process may examine the bids and may determine which layout is more likely to generate revenue for the auctioneer. The layout that is forecast to generate the highest revenue may be used.

For example, a three-slot mainline may be likely to generate a greater number of clicks overall than an exclusive mainline, due to the greater number of options for the user to click. On the other hand, the amount that the first-ranked bidder is willing to pay for click might make it worth it for the auctioneer to exclude the second- and third-ranked bidders from the mainline in order to focus the user's attention on the first-ranked bidder, and to charge the first-ranked bidder an appropriately-high price per click. Calculating the expected revenue for each layout allows the auction process to determine which layout is expected to maximize click revenue for the auctioneer, and the auction process can choose a layout accordingly. Moreover, when the only option is a plural-slot mainline, many bidders tend to underbid, since they know that they can obtain mainline placement even without being the first-ranked bidder in the auction. By putting the advertising layout “in play” in the auction, bidders are discouraged from underbidding, since there is a risk that that an underbidder's ad would be excluded from mainline placement.

While mainline versus shared exclusivity is one set of layout options, in greater generality there could be any number of different layouts, and an auction could be used to determine which layouts will be used. Moreover, while advertising slots are generally auctioned for placement on search results pages, the subject matter herein is not limited to search engines but rather may be used in any context in which the selection and/or placement of ads is based on some sort of variable content. For example, an auction could be used to place ads on a page of a web mail site, a blog, a new site, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example user interface for a web application in which advertisements are displayed.

FIG. 2 is a flow diagram of an example process in which an auction may be used to determine an advertising layout.

FIG. 3 is a block diagram of an example system in which an auction may be used to display advertisements in various layouts.

FIG. 4 is a block diagram of an example set of inequalities that may be used to determine whether to use a layout with an exclusive or three-slot mainline.

FIG. 5 is a block diagram of example components that may be used in connection with implementations of the subject matter described herein.

### DETAILED DESCRIPTION

Advertising space on web pages is normally sold in an auction. Examples of web pages where advertising space is sold include pages generated by search applications, portals, web mail systems, and other types of web sites. In general, entities that would like to promote their web sites bid on certain keywords. The web application that is auctioning off advertising space typically designates certain “slots” on a page in which paid (or “sponsored”) links are to be displayed. If the keyword is triggered in the web application (e.g., when a user enters the keyword into the search box on a search application), then some or all of the bidders for that keyword are awarded advertising slots on the page by having links to their web sites displayed in the slots. If a user clicks a link in one of the displayed advertising slots (referred to in web advertising as a “click through”), then the auctioneer of the slots (which is typically the operator of the web site on which advertising is being sold, but could be a third-party entity) charges the bidder an amount of money as payment for successfully directing a user to the bidder's site. The amount of money charged is based on the result of the auction.

Auctions can take various forms. Different types of auctions are well-defined and have been subject to rigorous mathematical analysis. For web advertisements, a type of auction that is typically held is a “generalized second price” (or “GSP”) auction. In a GSP auction for web advertisements, entities bid specific amounts of money for keywords. The amount bid, in theory, represents the amount of money that the bidder is willing to pay for a click-through to its link, in the event that the link is displayed in response to a user searching for that keyword. So, companies A, B, and C might submit, to the operator of a search engine, the bids of $10, $5, and $2 respectively for the keyword “cars”. Each bid might specify a link that the bidder would like to have displayed in an advertising slot. If a user of the search engine enters the query “cars”, then the search engine might display links to the web sites of companies A, B, and C in the first, second, and third advertising slots on the search results page. (In reality, slots are normally awarded in an order that depends on the amount of revenue that the auctioneer expects from awarding a particular slot to a particular bidder; details of how the slots are awarded are described below.) If any of these advertisements results in a click-through, then the bidder is charged some amount per click (“cost per click”, or “CPC”), where the CPC is based on the next lowest bidder's bid (or where the amount is derived in some other manner). Thus, if A gets a click-through, then A is charged an amount that is typically one penny more (or a fraction of a penny more) than the auctioneer could have realized if it had awarded the slot to any of the other bidders. (Again, the details of how the CPC is calculated are described below. Moreover, the subject matter herein applies to situations where the amount charged to the bidder is derived in some other way—e.g., the subject matter herein applies to situations where the amount the bidder is charged is as described above, or where the bidder is charged the full amount of its bid, or where the amount to be charged to the bidder is determined in some other way.)

Advertising slots are generally accepted to have different values, based on their likelihood of generating a click. For example, a typical search results page might have three “mainline” slots and five “sidebar” slots, where the mainline slots appear at the top of the page above the algorithmic search results, and the sidebar slots appear off to the side of the search results. The mainline slots are generally considered to be more valuable than the sidebar results, due to mainline slots' higher visibility and their proximity to the algorithmic search results. Moreover, among the mainline and sidebar slots, those slots closer to the top of the page are generally considered to be more valuable than slots lower down the page—possibly due to the fact that users might assume that links appearing near the top of a page have higher relevance than slots further down the page. In the field of web advertising one may speak of “expected revenue per impression” (“ERPI”), where an “impression” is an instance of displaying a paid link. The ERPI is a forecast of how much revenue will be received from an impression of a particular link, where the forecast might be based on certain assumptions such as the idea that, over a statistically large sample of impressions, users' future click behavior will be similar to past click behavior. In general, the auctioneer employs a ranking function to rank the various bids in order—e.g., in the example above, company A might be first-ranked, company B might be second-ranked, and so on. Any sort of ranking function could be used, but typically the ranking function ranks bids in order of ERPI (which may be calculated using techniques described below), or some value from which ERPI may be derived (such as the Monetization Value described below). Thus, typically the bidder with the highest ERPI gets the highest-value slot on the page, the bidder with the next highest ERPI gets the slot with the second highest value, and so on.

One issue that arises in selling advertising slots is that there is nothing more valuable to sell than the top advertising slot in a fixed layout. Assuming a slot layout of mainline and sidebar slots, as described above, there is nothing more valuable for the auctioneer to sell than the mainline slot with the highest position on the page. The top slot is assigned to the first-ranked bidder, and the cost per click (“CPC”) for that bidder's link is set just high enough that the auctioneer loses no revenue by assigning the slot to the second-ranked bidder. The first-ranked bidder might have been willing to pay more per click for even more prominent placement on the page, but since the auctioneer has nothing more prominent to sell than the highest slot on the page, the auctioneer has no basis to charge the bidder more per click than the minimum amount that makes the first-ranked bidder more profitable in the highest slot than the second-ranked bidder would be. Compounding problems for the auctioneer is the fact that, by having the bidder with the top ERPI share the mainline slots with other bidders that have lower ERPIs, the auctioneer is setting up competition against its top revenue source. If A, B, and C share three mainline slots, but B and C have a much lower CPCs than A, then there is a reasonable chance that a user would pass over A's link and instead click B's link or C's link, thereby generating less revenue for the auctioneer than if the user had clicked A's link. The auctioneer could offer only a single mainline slot, or could set a reserve price for the mainline slots, but these solutions may create more problems than they solve. The dynamics of bidding are complicated and highly situation-dependent, but either of these solutions could reduce expected revenue for the auctioneer. Offering a single mainline slot might discourage some bidders from attempting to gain the slot, thereby reducing competition at the high end of the bid range (and, thereby, reducing the cost per click assigned to the mainline slot). And setting a reserve may have the effect of pushing some advertisers to the sidebar, thereby reducing the chance that their links will be clicked at all, which, again, may have the effect of reducing revenue to the auctioneer.

The subject matter herein puts the advertising layout itself into play in the auction. Adding this additional variable to the auction may increase competition among bidders, thereby encouraging higher bids. Additionally, in some circumstances the layout that is chosen may increase the prominence of the link with the highest CPC, thereby increasing the likelihood that the user will click that link instead of links with lower CPC, and consequently increasing the revenue to the auctioneer. In one example, the layout options that are offered are exclusive versus non-exclusive mainlines, where mainline exclusivity—if granted—knocks all bidders except for the first-ranked bidder off the mainline. However, in greater generality, any layout option could be put into play: A number of layout options offering various amounts of favorability (or unfavorability) to bidders could be offered as possibilities, and the particular layout that is chosen could be determined based on the nature of the bids.

In the example where there are two layout options—one with plural mainline slots, and one with a single exclusive mainline slot—the auction might work as follows. Bids would be collected for a given keyword as in a standard GSP auction. The auctioneer then ranks the bidders using its ranking function and calculates the expected revenue from two possible assignments of the slots. The first slot assignment assumes that the first layout with plural mainline slots will be used. The second slot assignment assumes that an exclusive mainline slot will be offered, and that all other bidders will be pushed to the sidebar. If the revenue expected from the layout with an exclusive mainline slot exceeds the revenue expected from a layout with plural mainline slots, then the layout with mainline exclusivity may be used. It is noted that this comparison represents a number of tradeoffs. If mainline exclusivity is used, then the second and third bidders (who may each have a relatively high CPC) are pushed to the sidebar, where their chance of being clicked decreases significantly. So, granting the top-ranked bidder mainline exclusivity may forfeit some revenue from the second- and third-ranked bidder. On the other hand, if the layout with plural mainline slots is used, then the second- and third-ranked bidders are prominently-displayed distractions from the highest-ranked bidder, which may decrease revenue to the auctioneer by encouraging users to click the second- and third-ranked bidders' advertisement (which usually have lower CPCs than the highest-ranked bidder). Historical analysis of user's click behavior can determine how behavior would change under different layouts, and the expected behavior of users—and, therefore, expected revenue from a particular layout—can be quantified using such analysis.

It will be understood that the binary choice of plural mainline slots versus mainline exclusivity is merely an example. In general, any number of different layouts could be offered, and the behavior of users in response to the different layouts could be quantified. Thus, the auctioneer could compare the expected revenue from various different layouts, and —for any given impression—could choose the layout that maximizes revenue to the auctioneer.

By putting layout into play in an auction, the auctioneer is given an additional tool to maximize its revenue. Additionally, bidders are encouraged not to underbid, since each bidder would be concerned about receiving an unfavorable layout if its bid is too low relative to other bids. There are various scenarios in a traditional GSP auction in which a bidder can increase its expected utility by bidding less than the true value that the bidder places on receiving a click. Putting the layout into play reduces some of the incentive to underbid. If bidders are encouraged to bid closer to the true value of a click, then the slot assignment that maximizes revenue to the auctioneer is also likely to be the slot assignment that provides the maximal aggregate utility across all of the bidders.

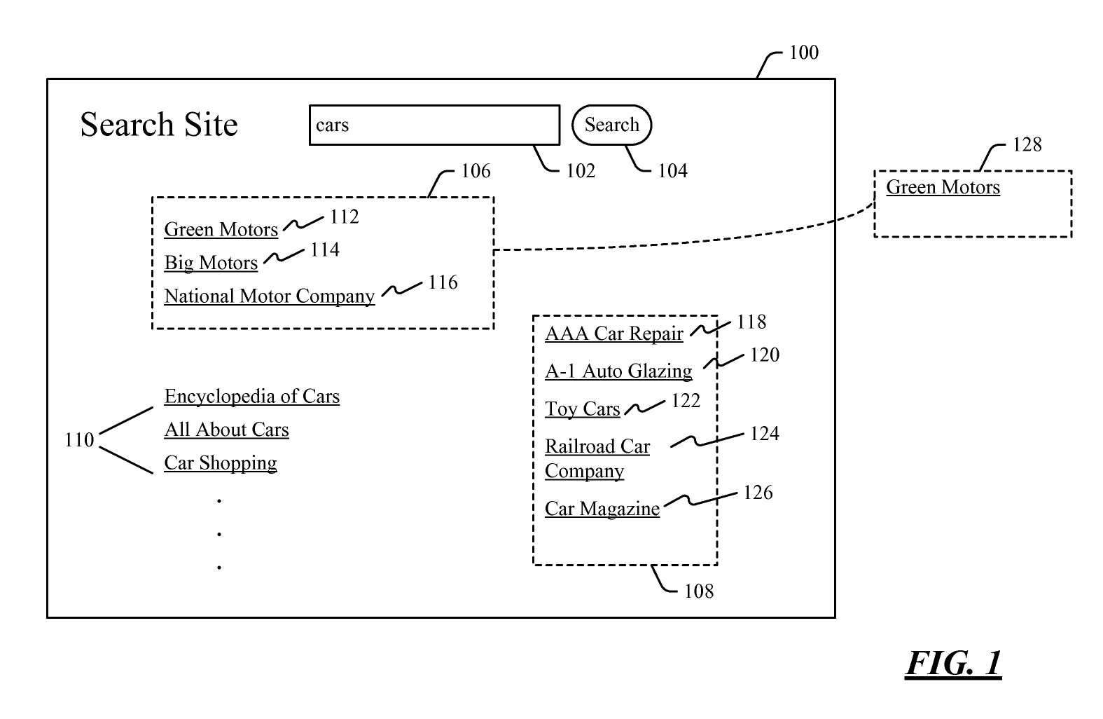

Turning now to the drawings, FIG. 1 shows an example user interface 100 for a web application in which advertisements are displayed. User interface 100 is for a search web site (e.g., the Microsoft BING service, Google, Cuil, etc.), which is a typical web application that displays advertisements. However, the subject matter herein applies to any type of web application in which advertisements or paid links could be displayed. Some other examples are web mail applications, sports or news web sites, video sharing sites, blogging sites, or any site in which an advertiser might want to display an advertisement to a user.

With regard to the example in which user interface 100 is for a search site, user interface 100 may include a search box 102 and search button 104. As with a typical search site, a user enters keywords into search box 102 and clicks search button 104 to obtain a set of results. In the example of FIG. 1, the user has entered a query containing the word “cars”.

The set of results produced by the search application has various components. In one example, these components include an advertising mainline 106, an advertising sidebar 108, and a set of algorithmic results 110. The advertising mainline 106 contains a plurality of slots 112, 114, and 116. The advertising sidebar 108 also contains a plurality of slots 118, 120, 122, 124, and 126. (Three mainline slots and five sidebar slots are shown in FIG. 1, although the mainline could contain any number of slots.) Each of the mainline and sidebar slots has a link. The link is associated with a particular bidder—i.e., a given bidder (such as Green Motors) bids on the keyword “cars” to have its link displayed in an advertising slot when the term “cars” is searched for. For example, slot 112 includes a link to the “Green Motors” web site. If slot 112 is considered the highest mainline slot, then the fact that the Green Motors link is placed there indicates that the bid from Green Motors was ranked first by the bid ranking function. If slot 114 is considered the second highest mainline slot, then the fact that “Big Motors” is listed there indicates that Big Motors' bid was ranked second by the bid ranking function. And so on, throughout the mainline slots, and then throughout the sidebar slots. FIG. 1 shows an example in which each slot is occupied by a link, although a slot could be unoccupied. For example, there could be an insufficient number of bids to fill all of the slots, or there could be a reserve for the mainline and/or sidebar slots which is not met by enough bids to meet the reserve. The algorithmic results 110 also contain links, but links in the algorithmic results 110 are chosen by a search algorithm rather than being sold by auction.

In the layout of user interface 100 that is shown, there are three mainline slots and five sidebar slots. However, in an alternative layout, there could be exactly one mainline slot, where the winning bidder gets exclusivity in the mainline. For example, if Green Motors is the highest-ranked bidder, then an alternative version of mainline 128 would contain only the Green Motors link. Awarding Green Motors mainline exclusivity would have the effect of pushing the second and third bidders into the sidebar (and, unless the number of slots in the sidebar is expanded to accommodate mainline exclusivity, would also push the seventh and eight bidders off the sidebar so that they would be omitted from the page's advertisements entirely). Mainline exclusivity thus represents an advantage to Green Motors. Techniques described herein may be used to determine whether the auction will give this advantage to Green Motors, in view of the other bids received for a given keyword.

Table 1 shows an example of several bids for a given keyword (e.g., “cars”), and various values that may be calculated with respect to those bids.

TABLE 1

| Bidder | Bid | CTR | MV$ | CPC | eCPI | Position | Pos. Adj. | eRPI |
|---|---|---|---|---|---|---|---|---|
| Green Motors | $6.75 | 7.37% | $0.49748 | $3.55 | $0.26 | ML-1 | 1.00 | $0.2600 |
| Big Motors | $2.70 | 9.68% | $0.26136 | $1.31 | $0.13 | ML-2 | 0.49 | $0.0637 |
| National Motor Co. | $2.52 | 5.05% | $0.12726 | $2.26 | $0.11 | ML-3 | 0.38 | $0.0418 |
| AAA Car Repair | $2.00 | 5.71% | $0.11420 | $1.31 | $0.07 | SB-1 | 0.13 | $0.0091 |
| A-1 Auto Glazing | $1.04 | 7.20% | $0.07488 | $0.81 | $0.06 | SB-2 | 0.11 | $0.0066 |
| Toy Cars | $1.13 | 5.13% | $0.05797 | $1.07 | $0.05 | SB-3 | 0.09 | $0.0045 |
| Railroad Car Co. | $1.13 | 4.88% | $0.05514 | $0.82 | $0.04 | SB-4 | 0.08 | $0.0032 |
| Car Magazine | $1.25 | 3.21% | $0.04013 | $1.04 | $0.03 | SB-5 | 0.07 | $0.0021 |
| | | | | | | | | $0.3910 eRPS |

In Table 1, the names of the various bidders for the “cars” keyword are shown in the “Bidder” column. The “Bid” column shows the bid made by that bidder. “CTR” stands for “click-through rate”, and the CTR column represents the click-through rate for a particular bidder. The CTR is the rate at which an impression in the highest slot on a page yields a click for a particular link (or for the bidder associated with that link). For example, in Table 1 Green Motors has a CTR of 7.37%, which means that if a link to Green Motors were shown 10,000 times in the highest-valued slot on a page (e.g., the first mainline slot), then the link in that slot would be clicked approximately 737 times. The Monetization Value (“MV$”) is a given site's bid times its CTR. Thus, if Green Motors bids $6.75 and has a CTR of 7.37%, then the Monetization Value of its bid is $6.75×0.0737−0.49748.

The remaining columns in Table 1 are: cost per click (“CPC”), expected cost per impression (“eCPI”), position, position adjustment, and expected revenue per impression (“eRPI”). The Position is the position that a given bidder has actually been awarded. The slots are designed as mainline (“ML”) or sidebar (“SB”), so “ML-1” indicates the first mainline slot, “ML-2” indicates the second mainline slot, and so on. The position adjustment is a factor that represents the relative probability of getting a click from a given slot. For example, ML-1 is the highest-valued slot on the page, and canonically it is assigned an adjustment of 1.0. Slot ML-2 is the second-highest valued slot on the page, and it has an adjustment of 0.49. This adjustment means that placing an ad in slot ML-2 makes it 49% as likely that the ad will generate a click as if the ad had been placed in slot ML-1. For an ad in slot ML-3, a click is 38% as likely as if the same ad had been placed in slot ML-1. Similarly, the sidebar slot, in the example of Table 1, have fractional position adjusters, indicating that these slots are far less likely than ML-1 to generate a click. (Slot ML-1 with a position adjustment of 1.0 may be considered the “normalized impression” whose expected revenue is represented by MV$. The expected revenue of the placement of a link in slots other than ML-1 may thus be determined by multiplying MV$ by the position adjustment for the slot in which the link is placed.) The actual position adjustments may be determined empirically, based on historical analysis of users' click behavior.

The eCPI (estimated cost per impression) is the cost per click (CPC) times the click-through rate (CTR), and the eRPI (estimated revenue per impression) is the eCPI times the position adjustment. For example, AAA Car Repair has been placed in slot SB-1. The CPC for that ad is $1.31, and the CTR is 5.71%. Thus, the eCPI is $1.31×0.0571≈0.07, and the eRPI is 0.07×0.13≈0.0091.

The actual cost per click (CPC) for a given bidder is determined by choosing the price at which the auctioneer could not make any more money by putting the next-lowest-ranked bidder in the slot that has been awarded to the given bidder. For example, in Table 1 Green Motors (the first-ranked bidder) has been awarded slot ML-1 at a price of $3.55 per click. The reason for awarding Green Motors this slot at this price can be explained as follows. Big Motors (the bidder with the second-place monetization value) bid $2.70 per click. If ML-1 had been awarded to Big Motors, then the expected revenue per impression that could be obtained from that from that slot would $2.70×0.0968×1.0=$0.26136 (i.e., Big Motors' maximum bid, times its click-through rate, times the Position Adjustment for slot ML-1). Thus, if Green Motors is willing to pay an amount per click that generates more than $0.26136 in revenue per impression, then it is worth it for the auctioneer to award ML-1 to Green Motors. The fact that Green Motors has a higher bid than Big Motors is not sufficient to determine whether awarding ML-1 to Green Motors increases the auctioneer's revenue, since it is possible that Green Motors would have such a low CTR as to offset the benefit of a higher price per click. (The auctioneer only gets paid if the impression actually results in a click, so the chance that the impression will result in a click is considered along with the actual price per click, and the position adjustment, when estimating the revenue generated by an impression.) Since Green Motors has to pay enough per click to generate at least the $0.26136 in revenue that the auctioneer could have realized by awarding ML-1 to Big Motors, the algebra that determines Green Motors' price is: CPC_{GreenMotors}×CTR_{GreenMotors}×PosAdj_{ML-1}=$0.26136, or CPC_{GreenMotors}×0.737×1.0=0.26136. Solving for CPC_{GreenMotors} yields CPC_{GreenMotors}≈$3.5462. So, rounding to the nearest penny, it is determined that charging Green Motors $3.55 per click justifies assigning ML-1 to Green Motors since, at that price, the auctioneer cannot increase revenue by assigning that slot to someone else. Similar analysis is performed for each of the lower slots—i.e., a given bidder is assigned a CPC such that the eRPI of assigning the given bidder to the slot is at least as much as the eRPI would be if the slot were assigned to the next-lowest-ranked bidder. (As noted above, charging a bidder the minimum amount per click such that the auctioneer cannot increase revenue by awarding the slot to a different bidder is merely one way to calculate the amount charged to a bidder. The subject matter herein applies to situations in which the amount to be charged to a bidder is calculated in any manner, and is not limited to the above-described way of determining the cost per click.)

The last row of Table 1 shows the estimated revenue per search (eRPS), which is the sum of the eRPIs for all of the slots. That is, ads are shown in the eight slots ML-1 through ML-3 and SB-1 through SB-5, each of which has a certain expected revenue based on the calculations described above. Thus, the eRPS is the aggregate amount of expected revenue from the impressions of eight ads in all eight slots.

The above process treats the assignment of slots to specific bidders, and the price per click to be charged to those bidders, as variables, while treating the layout of the slots as fixed. However, the subject matter described herein adds layout as an additional variable in the auction process, by providing a way of accounting for the expected return on different types of layouts. As described above, each slot has a position adjustment, which represents the relative value of that slot as compared with some normalized impression. Canonically, ML-1 is the normalized impression of an ad, so that slot is assigned a position adjustment of 1.0. Moreover, since slots that are lower in the mainline, and slots that are on the sidebar, are typically less valuable than ML-1, those other slots are assigned position adjustments of less than 1.0. (The fact that slots other than ML-1 are less valuable than ML-1 itself is determined by historical evidence of users' click behavior. In theory, other slots could be more valuable than ML-1, but in practice, when the layout comprises several mainline slots and several sidebar slots, the highest slot in the mainline tends to have the highest value.) As described above, a given bidder's CTR represents the rate at which impressions are expected to generate clicks if the bidder's ad is given the normalized impression (e.g., an impression in slot ML-1), but in order to find out the effective rate at which the impression generates clicks in a particular slot, the CTR is multiplied by the position adjustment—e.g., in Table 1, placement of an ad in slot ML-2 reduces the actual rate at which an impression generates clicks to 49% of that ad's normalized CTR.

However, if the layout is changed, then it is possible that the resulting layout would include a slot that is more likely to generate clicks than the normalized impression. For example, suppose that the mainline includes three slots, with the normalized impression being placement of the ad in slot ML-1. In such a layout, the ad in ML-1 competes for attention with ads placed in slots ML-2 and ML-3. If the layout is changed so that there is only one mainline slot (for example, a slot labeled ML-e, for “mainline exclusive”, which corresponds to the alternative mainline 128 shown in FIG. 1), then it is possible that ML-e is even more valuable than the normalized impression. The actual value of ML-e relative to the normalized impression, like other relative values, could be determined by analysis of users' click behavior. However, it can be understood intuitively that, in a three-slot mainline, the three slots compete with each other for the user's attention, so ML-2 and ML-3 draw the user's attention away from ML-1. If there is only a single mainline slot, ML-e, then that slot has no competition for a user's attention and thus may be more likely to generate clicks than the normalized impression in ML-1.

For example, suppose that placement of an ad in ML-e makes the ad 20% more likely to be clicked than if the same ad had been placed in ML-1. (A 20% increase is merely an example; analysis of users' click behavior could determine how likely ML-e is to generate a click relative to the normalized impression of ML-1. In general, for any layout of slots, analysis of users' click behavior could be used to determine how likely a slot is to generate a click relative to the normalized impression.) Then ML-e could be given a position adjustment of 1.2, representing the fact that a given ad is 1.2 times as likely to be clicked if the ad is placed in a position of mainline exclusivity than if the ad is given the normalized impression. This situation would increase the eRPI of the ad relative to placement in ML-1, since the impression is more likely to generate a click than if the ad had been placed in ML-1. On the other hand, this situation also reduces or eliminates the eRPI of the second and third ads, because placing the first ad in ML-e moves the second and third ads down to SB-1 and SB-2, where the position adjustment (and, thus, the likelihood of generating a click, is significantly lower than it would have been if those ads had been placed in ML-2 and ML-3). Whether it is worth it to the auctioneer to give the first-ranked bidder ML-e instead of ML-1 depends on whether the additional expected revenue from placing the ad in ML-e makes up for the loss of expected revenue that is caused by moving the second and third-ranked ads to the sidebar.

There are various ways to calculate which layout produces the highest revenue. As noted above, it is possible to calculate an eRPS, which represents the aggregate expected revenue from all of the slots on a given search results page. eRPS could be calculated for the different layouts, which would indicate which layout has the highest expected revenue for the auctioneer. Or, another simplified way to calculate which layout produces higher revenue is to calculate the value of the mainline in the two layouts. (Both of these techniques are examples of calculating the expected revenue of a layout; the concept of calculating the expected revenue of a layout includes situations in which fewer than all of the slots in the layout are considered in the calculation.) Using this simplified option with the example numbers in Table 1, the calculation is as follows:

The expected revenue per search of the mainline when there are three mainline slots is $0.3655. (I.e., the sum of the eRPI for the slots ML-1, ML-2, and ML-3 is $0.3655.) If the mainline were instead replaced with an exclusive mainline in which the highest-ranked bidder (Green Motors) is the only ad displayed on the mainline, then the expected revenue of the mainline would be equal to $0.3655 as long as the CPC for Green Motors is at least $4.1327. So, if Green Motors is assigned a CPC slightly greater than that break-even point (e.g., $4.14 per click), then the expected revenue for the mainline if Green Motors is awarded slot ML-e is: CTR_{GreenMotors}×CPC_{GreenMotors}×PosAdj_{ML-e}=0.0737×$4.14×1.2=$0.3661. This amount is slightly greater than the expected revenue for the three-slot mainline layout ($0.3655). Since $4.14 is less than Green Motors' bid of $6.70, Green Motors can be charged $4.14 per click. Giving Green Motors mainline exclusivity at this price increases the auctioneer's expected revenue as compared with giving a shared mainline to the three highest-ranked bidders.

Awarding exclusivity to Green Motors not only increases revenue to the auctioneer, but is also likely to increase the aggregate utility provided to the top three bidders. The amount of the bids indicate that a click is only worth $2.70 and $2.52, respectively, to the second- and third-ranked bidders, but is worth $6.70 to the highest-ranked bidder. By directing a larger proportion of clicks to a bidder that derives more value from the clicks, the overall value of users' clicks is increased. It may be the case that the bids do not represent the true value that the bidders place on clicks. A GSP auction is referred to as a “non-truthful” auction, which is a mathematical concept that describes an auction in which situations exist where a bidder has an incentive to bid less than the true value than it places on what it is bidding for. Thus, in a GSP auction, bidders sometimes have an economic incentive to underbid relative to the true value that they place on a click. While adding the possibility of mainline exclusivity (or, in greater generality, the possibility of providing alternative layouts) does not convert a GSP auction from a non-truthful auction to a truthful auction, it does give bidders an incentive to consider the risk of losing their mainline position when choosing an amount to bid. For example, Green Motors was able to win exclusivity (thereby reducing Big Motors and National Motors to negligible exposure on the sidebar) because Green Motors bid was significantly higher than that of the second- and third-ranked bidders. If Big Motors had bid a higher amount (e.g., $4.75 per click), then Big Motors still would not have won the ML-1 slot (since Big Motors' Monetization Value would only be $0.4598—not enough to beat Green Motors' bid times click-through rate of $0.49748). However, such a bid might keep Green Motors from winning exclusivity. For example, suppose that Big Motors and National Motors had bid $4.25 and $4.00 per click, respectively. Then, using the calculations described above, a three-slot mainline would still assign Green Motors, Big Motors, and National Motors to slots ML-1 through ML-3 in that order, but with a CPC of $6.23, $2.09, and $2.26, respectively. With those costs per click, the expected revenue of the mainline increases to $0.6006 per search (instead of $0.3655, which is the sum of the expected revenue for the three mainline slots in the example of Table 1). At an expected mainline revenue of $0.6006, Green Motors would have to pay $6.80 per click in order for an exclusive mainline to increase the expected revenue to the auctioneer. (I.e., CTR_{GreenMotors}×CPC_{GreenMotors}×PosAdj_{ML-e}=0.0737×$6.80×1.2=$0.6013, which is just greater than the $0.6006 expected revenue of a non-exclusive mainline.) However, $6.80 exceeds Green Motors' bid of $6.75, so by increasing their bids, Big Motors and National Motors have prevented Green Motors from receiving an exclusive mainline, and have prevented themselves from being knocked off the mainline. Of course, a click might not be worth $4.25 and $4.00 to Big Motors and National Motors, respectively, in which case they might choose not to bid those amounts. However, the possibility that bidding higher would prevent giving exclusivity to their competitor encourages those bidders to increase their bid upward toward the true value that the bidders place on receiving a click.

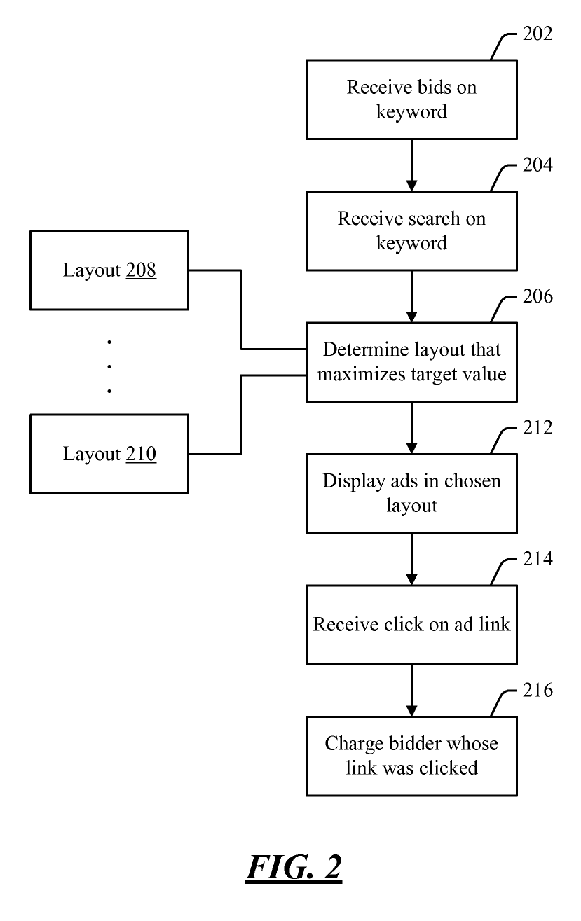

FIG. 2 shows, in the form of a flow chart, a process in which an auction may be used to determine an advertising layout. Before turning to a description of FIG. 2, it is noted that the flow diagram of FIG. 2 is described, by way of example, with reference to the scenario shown in FIG. 1, although this process may be carried out in any system and is not limited to the scenario shown in FIG. 1. Additionally, the flow diagrams in FIG. 2 shows an example in which stages of a process are carried out in a particular order, as indicated by the lines connecting the blocks, but the various stages shown can be performed in any order, or in any combination or sub-combination.

At 202, bids are received on a keyword. As in FIG. 1 and Table 1, “cars” is an example of a keyword, although the bids could be for any keyword. At 204, a search on the keyword is received. For example, a user may enter a query containing the word “cars” into the search box of a search engine web page. As noted above, search is one example of an application in which advertisements could be displayed. In other example, ads could be displayed in mail applications, sports or news applications, video sharing sites, bogging sites, etc., and the relevant keywords (i.e., the keywords that were received at 202) could be harvested from content on those sites. (When a user's private information is involved, such as in the case of web mail, appropriate measures could, of course, be taken to ensure that a user's private information is being protected from misuse.)

At 206, a determination is made as to which layout maximizes some target value. In the preceding examples, the value to be maximized is the expected revenue to the auctioneer as a result of presenting the layout, but the target value to be maximized could be some other value (e.g., expected utility of the bidders, etc.). Techniques for maximizing the target value are described above. For example, when the target value to be maximized is expected revenue per search, the auctioneer could calculate the cost per click and expected advertising revenue for the different bidders under various different layout scenarios, and could choose the layout that produces the maximum expected revenue. As described above, the choice of an exclusive mainline versus a three-slot mainline is one possible choice of different layout scenarios, although in general there could be any number of layout scenarios for the auctioneer to choose from. As shown in the example of FIG. 2, the determination made at 206 chooses from among an arbitrary number of layouts (the arbitrary number of layouts being indicated by the ellipsis between layout 208 and layout 210). Moreover, as noted above, the notion of calculating the expected revenue (or other target value) of a layout may be performed by considering all of the different slots on a layout, or may be performed by considering only some of the slots. For example, if the two layouts are (a) exclusive mainline plus a five-slot sidebar, and (b) a three-slot mainline plus a five-slot sidebar, the expected revenue of the different layouts may be compared by comparing the expected revenues of the two different mainline configurations, even if the expected revenue of the sidebars is not included in the calculation. To say that the expected revenues (or other target values) of a given layout are compared does not necessarily mean that that the comparison takes into account every slot in each layout. Thus, in one example, the expected revenue of two layouts that both have a mainline and a sidebar might be compared by comparing the expected revenues of the mainlines without regard to the expected revenues of the sidebars. (Of course, in an alternative example, both the mainline and sidebar sections of the layouts could be considered in the comparison.)

At 212, ads are displayed in the chosen layout. For example, the chosen layout might be one with an exclusive mainline and a five-slot sidebar, or might be one with a three-slot mainline and a five-slot sidebar, or could be any other layout. (Mainlines and sidebars are merely examples of layout sections; in general, the layout could be organized in any manner.)

At 214, a click may be received on one of the advertising links. As noted above, some impressions do not generate any paid clicks, but if an impression does generate a paid click, then the click is received at 214. Assuming that a paid click has been received, the bidder whose link was clicked is charged (at 216) for the click at the CPC that the auction process has assigned to that bidder.

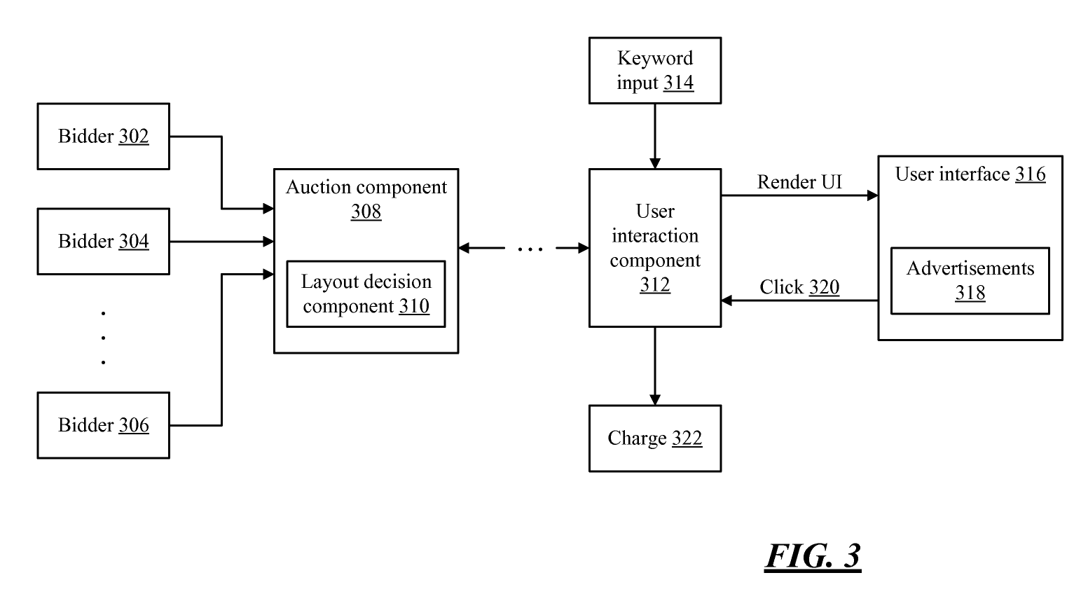

FIG. 3 shows an example system in which an auction may be used to display advertisements in various layouts. In the system of FIG. 3, a plurality of bidders (e.g., bidders 302, 304, and 306) provide bids on a particular keyword to an auction component 308. Auction component 308 may, for example, comprise software that runs on a server computer and that receives bids from participants in a search engine's advertising program. Auction component 308 may determine the assignment of slots to bidders and the respective bidders' cost per click (CPC), based on the bids that have been received. Moreover, auction component 308 may include a layout decision component 310, which assists auction component 308 in identifying the layout to be presented to a user. Layout decision component 310 may identify the appropriate layout based on the principles described above (e.g., choosing a layout that maximizes revenue to the auctioneer).

User interaction component 312 may receive keyword input 314, in some form, from a user. For example, user interaction component 312 could be the front end of a search engine, which receives the keyword in the form of a query. Or, user interaction component 312 could be part of a different type of application (e.g., a sports web site, a news web site, a video sharing web site, a blogging web site, etc.), and could harvest keywords from content posted to such web sites. User interaction component 312 could receive keyword input 314 in any manner.

When keyword input has been received, user interaction component 312 may communicate (either directly or indirectly) with auction component 308 to determine what ads to display to a user. In response to this communication, auction component 308 runs an auction process to determine, based on bids that have been received, which ads are to be displayed to a user. As part of the auction process, auction component 308 may use layout decision component 310 to choose one of several layouts. Once the layout and the assignment of slots have been chosen, auction component 308 may communicate the layout and the assignment of slots to user interaction component.

User interaction component may then cause a user interface 316 to be rendered, which may contain the advertisements 318 in the chosen layout and with the chosen slot assignments, as well as other content. For example, if the application in which advertisements are being displayed is a search engine, then user interface 316 may include algorithmic search results, as well as advertisements in the form of sponsored links.

At some point in time after user interface 316 is rendered, a click 320 may be received on one of the sponsored links. If such a click is received, then user interaction component 312 is notified that the link has been clicked, and issues a charge 322 to be charged to the bidder associated with that link (e.g., the bidder that submitted the link with a bid). Charge 322 may be made in any form or at any time, and does not necessarily mean that money flows from the bidder to the auctioneer (or to another party) contemporaneously with the click. For example, payment 322 may be made by putting a debit on the bidder's account, where the account may be settled with actual money some number of days, weeks, months, or years in the future. In such a case, a charge may be deemed to be made when the debit is placed on the bidder's account.

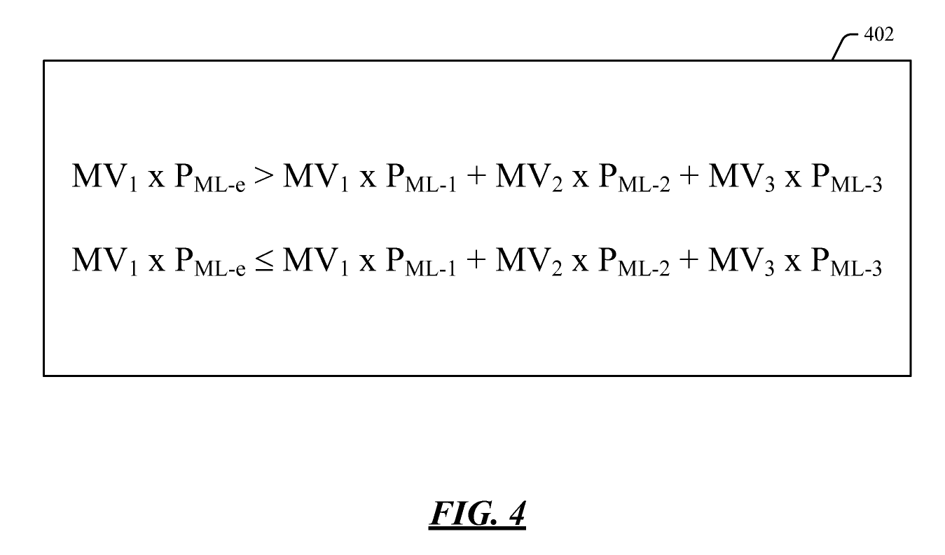

There are various ways to determine which layout to use. However, in the example where the choice of layout includes either a three-slot mainline or an exclusive mainline, FIG. 4 shows one example way to determine whether to use a layout with an exclusive or three-slot mainline.

Conditions 402 are inequalities that may be used to determine which layout to offer. In FIG. 4, MVₙ is the Monetization Value of the n-th ranked bidder (i.e., the n-th bidder's bid multiplied by its click-through rate), and Pᵢ is the position adjustment of the i-th slot. With reference to the example layouts described above, P_{ML-1} would be 1.0, and P_{ML-e} would be 1.2. The expected revenue for placing the n-th bidder's ad in slot i is MVₙ×Pᵢ. Thus, in accordance with principles described above, if the auctioneer seeks to maximize revenue from the layout, then mainline exclusivity may be given to the first-ranked bidder if the following inequality holds:

MV₁×P_{ML-e}>MV₁×P_{ML-1}+MV₂×P_{ML-2}+MV₃×P_{ML-3}.

On the other hand, the layout with plural slots results in higher revenue to the auctioneer—and thus may be the layout that is used—if the following inequality holds:

MV₁×P_{ML-e}≦MV₁×P_{ML-1}+MV₂×P_{ML-2}+MV₃×P_{ML-3}.

In the above inequalities, it is assumed that there are three bidders that qualify for mainline placement. However, if there are only two bidders who qualify for mainline placement (either because the keyword in question has received only two bidders, or because only two of the bidders have met the mainline reserve), then the last additive term in each inequality (MV₃×P₃) may be omitted.

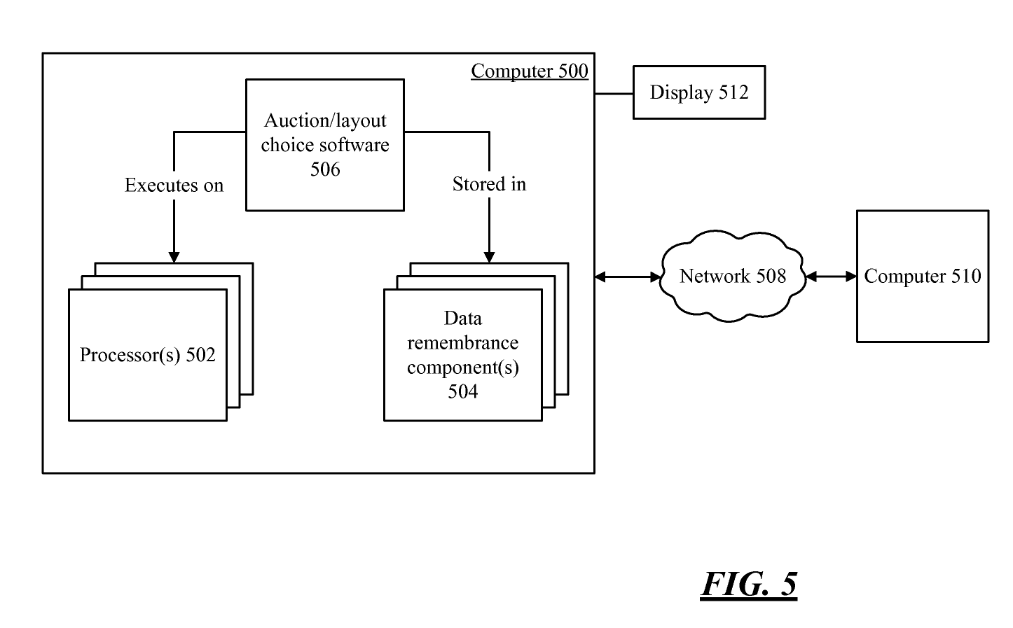

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is auction/layout choice software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable storage media. (A tangible medium, such as a magnetic disk or optical disk, is an example of a storage medium.) Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that comprise executable instructions to assign placement of advertisements, wherein the executable instructions, when executed by a computer, cause the computer to perform acts comprising:
receiving, from a plurality of bidders, a plurality of bids on a keyword, each bid comprising an amount of money that a bidder will pay to receive a click on that bidder's link;
receiving a search query that comprises said keyword;
calculating revenue forecasts for a plurality of layouts of advertisements by using information that comprises the bids;
identifying a first one of said plurality of layouts for which the forecast revenue for displaying said first one of said plurality of layouts is higher than the forecast revenue for displaying any other of said plurality of layouts;
displaying, to a user, advertisements in said first one of said plurality of layouts, wherein one of the advertisements comprises a first link of one of the bidders; and
receiving a click on said first link.

2. The one or more computer-readable storage media of claim 1, wherein said plurality of layouts comprise:
a first layout that comprises a first mainline having a plurality of slots and a first sidebar having a plurality of slots; and
a second layout that comprises a second mainline having exactly one slot and a second sidebar having a plurality of slots.

3. The one or more computer-readable storage media of claim 1, wherein each of the plurality of layouts comprises a plurality of slots, wherein each slot has an assigned position adjustment factor, wherein the forecast revenue of an impression in a given slot is calculated by multiplying the click-through rate associated with a link by the cost per click associated with that link by the position adjustment factor associated with the slot in which the link is placed, and wherein said plurality of layouts comprise:
a first layout that comprises a first mainline having a plurality of slots, the one of the plurality of slots that appears highest in said first mainline having a first position adjustment factor; and
a second layout that comprises a second mainline that has exactly one slot, the exactly one slot having a second position adjustment factor that is greater than said first position adjustment factor.

4. The one or more computer-readable storage media of claim 1, wherein said first one of said plurality of layouts is chosen from among said plurality of layouts, and links are assigned to slots in said first one of said plurality of layouts, by a process that comprises a generalized second price auction.

5. The one or more computer-readable storage media of claim 1, wherein said information that is used in calculating of said revenue forecasts further comprises click-through rates of the plurality of bidders, or click-through rates of the links submitted by said plurality of bidders.

6. The one or more computer-readable storage media of claim 1, wherein said plurality of layouts comprise:
a first layout that comprises a first mainline having a plurality of slots; and
a second layout that comprises a second mainline having exactly one slot; wherein using said second layout causes the forecast revenue of one or more links to be reduced or eliminated relative to what the forecast revenue of those links would be if said first layout is chosen, and wherein said acts further comprise:
determining that an increase in revenue that is forecast to result from displaying a first link in the exactly one slot of said second mainline is equal to or greater than the revenue that is lost as a result of not displaying said one or more links in a mainline position.

7. The one or more computer-readable storage media of claim 1, wherein said plurality of layouts comprise:
a first layout that comprises (a) a first mainline having a plurality of slots and (b) a first sidebar having a plurality of slots; and
a second layout that comprises (a) a second mainline having exactly one slot and (b) a second sidebar having a plurality of slots;
and wherein said identifying of said first one of said plurality is performed by comparing the forecast revenue of the first mainline with the forecast revenue of the second mainline without regard to the forecast revenue of the first sidebar and of the second sidebar.

8. A system for assigning placement of advertisements, the system comprising:
a processor;
a data remembrance component;
an auction component that executes on said processor, that is stored in said data remembrance component, and that receives a plurality of bids, each bid specifying a link to be advertised and an amount of money that a bidder is willing to pay to receive a click on the link, there being a plurality of layouts in which each layout comprises a plurality of slots in which a link can be displayed, the auction component determining, for each of the plurality of layouts:
in which slots, in a given layout, to place links submitted with bids in order to maximize forecast revenue from displaying the layout; and
a cost per click to be assigned to each link, said cost per click being based on information that comprises: (a) a given bidder's bid and (b) a click-through rate that is associated with the given bidder or with the given bidder's link; said auction component identifying a first one of the plurality of layouts for which the forecast revenue for displaying said first one of the plurality of layouts is greater than the forecast revenue for displaying any other one of the plurality of layouts; and
a user interaction component that causes said first one of the plurality of layouts to be presented to a user.

9. The system of claim 8, wherein said plurality of layouts comprises:
a first layout that comprises a first mainline having a plurality of slots and a first sidebar having a plurality of slots; and
a second layout that comprises a second mainline having exactly one slot and a second sidebar having a plurality of slots.

10. The system of claim 8, wherein each of said plurality of layouts comprises a plurality of slots, wherein each slot has an assigned position adjustment factor, wherein the forecast revenue of an impression in a given slot is calculated by multiplying the click-through rate associated with a link by the cost per click associated with that link by the position adjustment factor associated with the slot in which the link is placed, and wherein said plurality of layouts comprise:
a first layout that comprises a first mainline having a plurality of slots, the one of the plurality of slots that appears highest in said first mainline having a first position adjustment factor; and
a second layout that comprises a second mainline that has exactly one slot, the exactly one slot having a second position adjustment factor that is greater than said first position adjustment factor.

11. The system of claim 8, wherein said auction component performs a generalized second price auction to choose said first one of the plurality of layouts to present to said user, and to assign links to slots in said first one of the plurality of layouts.

12. The system of claim 8, wherein said plurality of layouts comprise:
a first layout that comprises a first mainline having a plurality of slots; and
a second layout that comprises a second mainline having exactly one slot;
wherein using said second layout causes the forecast revenue of one or more links to be reduced or eliminated relative to what the forecast revenue of those links would be if said first layout is chosen, and wherein said auction component determines that the revenue that is forecast to result from displaying a first link in the exactly one slot of said second mainline is equal to or greater than the revenue that is lost as a result of not displaying said one or more links in a mainline position.

13. The system of claim 8, wherein said plurality of layouts comprise:
a first layout that comprises (a) a first mainline having a plurality of slots and (b) a first sidebar having a plurality of slots; and
a second layout that comprises (a) a second mainline having exactly one slot and (b) a second sidebar having a plurality of slots;
and wherein said auction component identifies said first one of said plurality of layouts by comparing the forecast revenue of the first mainline with the forecast revenue of the second mainline without regard to the forecast revenue of the first sidebar and of the second sidebar.

14. A method of assigning placement of advertisements, the method comprising:
using a processor to perform acts comprising:
receiving a plurality of bids on a keyword, each of the bids comprising:
a link; and
an amount of money that a bidder is willing to pay to receive a click on the link;
receiving a search query that comprises the keyword;
identifying a first one of a plurality of layouts such that displaying said first one of the plurality of layouts to a user provides more forecast revenue than displaying to the user any of the other of the plurality of layouts, wherein the plurality of layouts comprise:
a first layout that comprises a plurality of mainline slots and a plurality of other slots; and
a second layout that has exactly one mainline slot, a plurality of other slots, and no mainline slots other than said exactly one mainline slot;
displaying said first one of the plurality of layouts to the user;
receiving a first click on a first link that is in one of the slots in the first one of the plurality of layouts; and
in response to having received said first click, charging the bidder associated with said first link.

15. The method of claim 14, wherein each of the plurality of layouts comprises a plurality of slots, wherein each slot has an assigned position adjustment factor, wherein the forecast revenue of an impression in a given slot is calculated by multiplying the click-through rate associated with a link by the cost per click associated with that link by the position adjustment factor associated with the slot in which the link is placed, wherein the mainline slot that appears highest in the mainline of said first layout has a first position adjustment factor, and wherein the exactly one slot in the mainline of the second layout has a second position adjustment factor that is greater than said first position adjustment factor.

16. The method of claim 14, wherein said first one of said plurality of layouts is chosen from among said plurality of layouts, and links are assigned to slots in said first one of said plurality of layouts, by a process that comprises a generalized second price auction.

17. The method of claim 14, wherein said acts further comprise:
calculating forecasts of revenue of each layout by calculating the sum of the forecast revenue for each slot in a given layout, wherein the revenue of a given slot is calculated based on information that comprises the cost per click of the link assigned to a slot and the click-through rate of that link or its associated bidder.

18. The method of claim 14, wherein using said second layout causes the forecast revenue of one or more links to be reduced or eliminated relative to what the forecast revenue of those links would be if said first layout is used, and wherein said acts further comprise:
determining that the revenue that is forecast to result from displaying a first link in the exactly one slot of the mainline of the second layout is equal to or greater than the revenue that is lost as a result of not displaying said one or more links in a mainline position.

19. The method of claim 14, wherein said identifying of said first one of said plurality is performed by comparing the forecast revenue of the mainlines slots in the first layout with the forecast revenue of the exactly one mainline slot in the second layout without regard to the forecast revenue of the plurality of other slots in the first layout and of the plurality of other slots in the second layout.

20. The method of claim 14, wherein said acts further comprise:
determining that a reserve price for a layout, or for a section of a layout, has been met by one of the plurality of bids.
